(19) United States
(12) Patent Application Publication
(10) Pub. No.: US 2024/0334509 A1
(43) Pub. Date: Oct. 3, 2024

(54) METHOD AND DEVICE FOR DIRECT COMMUNICATION IN COMMUNICATION SYSTEM SUPPORTING MULTIPLE LINKS

(71) Applicant: ELECTRONICS AND TELECOMMUNICATIONS RESEARCH INSTITUTE, Daejeon (KR)

(72) Inventors: Sung Hyun HWANG, Daejeon (KR); Kyu Min KANG, Daejeon (KR); Jae Cheol PARK, Daejeon (KR); Jin Hyung OH, Daejeon (KR); Dong Woo LIM, Daejeon (KR); Su Na CHOI, Daejeon (KR); Yong Ho KIM, Incheon (KR); Ju Seong MOON, Osan-si, Gyeonggi-do (KR)

(21) Appl. No.: 18/577,987

(22) PCT Filed: Jul. 12, 2022
(86) PCT No.: PCT/KR2022/010128

§ 371 Date: Jan. 9, 2024

(30) Foreign Application Priority Data
Jul. 12, 2021 (KR) 10-2021-0091192

(51) Int. Cl. H04W 76/14; H04W 76/12

(52) U.S. Cl. CPC H04W 76/14; H04W 76/12

(57) ABSTRACT

A method and a device for direct communication in a communication system supporting multiple links are disclosed. A method of an AP MLD comprises the steps of: transmitting a trigger frame in multiple links including a first link and a second link; receiving a response frame for the trigger frame from a first STA associated with an STA MLD in the first link; receiving a first data frame from a third STA in the second link; and when a subject to receive the first data frame is a second STA associated with the STA MLD, transmitting a second data frame generated on the basis of the first data frame, to the first STA in the first link.

### TECHNICAL FIELD

The present disclosure relates to a wireless local area network (LAN) communication technique, and more particularly, to a technique for protecting direct communication based on a tunneled direct link setup (TDLS) in a wireless LAN system supporting a multi-link.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

The standards using the wireless LAN technology are being standardized as IEEE802.11 standards mainly in the Institute of Electrical and Electronics Engineers (IEEE). As the above-described wireless LAN technologies have been developed and spread, applications using the wireless LAN technologies have been diversified, and a demand for a wireless LAN technology supporting a higher throughput has arisen. Accordingly, a frequency bandwidth (e.g., ‘maximum 160 MHz bandwidth’ or ‘80+80 MHz bandwidth’) used in the IEEE 802.11ac standard has been expanded, and the number of supported spatial streams has also increased. The IEEE 802.11ac standard may be a very high throughput (VHT) wireless LAN technology supporting a high throughput of 1 gigabit per second (Gbps) or more. The IEEE 802.11ac standard can support downlink transmission for multiple stations by utilizing the MIMO techniques.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since the multi-link operation is an operation that is not defined in the existing WLAN standard, it may be necessary to define detailed operations according to the environment in which the multi-link operation is performed. In particular, in order to transmit data in a multi-link, a method for direct communication in a blindness period may be required according to a channel access method and functions of a communication node in each link.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for TDLS-based direct communication in a wireless LAN system supporting a multi-link.

### Technical Solution

An operation method of an access point (AP) multi-link device (MLD), according to a first exemplary embodiment of the present disclosure for achieving the above-described objective, may comprise: transmitting a trigger frame in a multi-link, the multi-link including a first link and a second link; receiving, from a first station (STA) affiliated with a STA MLD, a response frame to the trigger frame in the first link; receiving, from a third STA, a first data frame in the second link; and when a destination of the first data frame is a second STA affiliated with the STA MLD, transmitting a second data frame generated based on the first data frame to the first STA in the first link, wherein the second link is a link established for direct communication between the second STA and the third STA.

The method may further comprise performing a communication procedure initiated by the trigger frame with the first STA in the first link, wherein the second data frame is transmitted based on a tunneling scheme after completion of the communication procedure.

A data frame transmitted from the AP MLD to the first STA in the communication procedure may include a ‘more data’ field, and the ‘more data’ field may be set to indicate that the second data frame is transmitted after the data frame.

The method may further comprise transmitting, to the third STA, a reception response frame to the first data frame in the second link, wherein a duration field included in the reception response frame may be set to indicate a completion time point of a communication procedure initiated by the trigger frame.

A reception operation of the second STA affiliated with the STA MLD may be determined not to be performed in the second link in a period from a transmission time point of the response frame to a completion time point of a communication procedure initiated by the trigger frame.

The method may further comprise transmitting, in the second link, an action frame including an identifier of the second STA that cannot perform a reception operation in the second link or information on a period in which the reception operation cannot be performed in the second link.

The second data frame may include a medium access control (MAC) header, a payload, and a frame check sequence (FCS) field, and the payload may include the first data frame.

The second data frame may include a MAC header, a payload, and an FCS field, the MAC header may include a receiver address (RA) field, a transmitter address (TA) field, and a source address (SA) field, the RA field may be set to an address of the STA MLD or the first STA, the TA field may be set to an address of a first AP affiliated with the AP MLD, the SA field may be set to an address of the third STA, and the payload included in the second data frame may be identical to a payload included in the first data frame.

When an enhanced multi-link single radio (EMLSR) operation or an enhanced multi-link multi radio (EMLMR) operation is supported, the second data frame may be transmitted using multiple spatial streams.

An operation method of a station (STA) MLD, according to a second exemplary embodiment of the present disclosure for achieving the above-described objective, may comprise: configuring a second link in a multi-link including a first link and the second link as a tunneled direct link setup (TDLS) link for direct communication with a third STA; receiving, from an access point (AP) MLD, a trigger frame in the multi-link; transmitting, to the AP MLD, a response frame to the trigger frame in the first link; performing a communication procedure initiated by the trigger frame with the AP MLD in the first link; and receiving, from the AP MLD, a first data frame including a TDLS data unit in the first link, wherein a reception operation of the STA MLD is not performed in the second link after transmission of the response frame, and the TDLS data unit is transmitted from the third STA to the STA MLD in a period in which the reception operation of the STA MLD is not performed in the second link.

The first data frame may be received based on a tunneling scheme after completion of the communication procedure.

The period in which the reception operation of the STA MLD is not performed may be a period from a transmission time point of the response frame to a completion time point of the communication procedure initiated by the trigger frame.

A data frame received from the AP MLD in the communication procedure may include a ‘more data’ field, and the ‘more data’ field may be set to indicate that the first data frame is transmitted after the data frame.

When an enhanced multi-link single radio (EMLSR) operation or an enhanced multi-link multi radio (EMLMR) operation is supported, the first data frame may be received using multiple spatial streams.

An AP MLD, according to a third exemplary embodiment of the present disclosure for achieving the above-described objective, may comprise: a processor; and a memory storing one or more instructions executed by the processor, wherein the one or more instructions are executed to: transmit a trigger frame in a multi-link, the multi-link including a first link and a second link; receive, from a first station (STA) affiliated with a STA MLD, a response frame to the trigger frame in the first link; receive, from a third STA, a first data frame in the second link; and when a destination of the first data frame is a second STA affiliated with the STA MLD, transmit a second data frame generated based on the first data frame to the first STA in the first link, wherein the second link is a link established for direct communication between the second STA and the third STA.

The one or more instructions may be further executed to perform a communication procedure initiated by the trigger frame with the first STA in the first link, wherein the second data frame may be transmitted based on a tunneling scheme after completion of the communication procedure.

A data frame transmitted from the AP MLD to the first STA in the communication procedure may include a ‘more data’ field, and the ‘more data’ field may be set to indicate that the second data frame is transmitted after the data frame.

The one or more instructions may be further executed to transmit, to the third STA, a reception response frame to the first data frame in the second link, wherein a duration field included in the reception response frame may be set to indicate a completion time point of a communication procedure initiated by the trigger frame.

A reception operation of the second STA affiliated with the STA MLD may be determined not to be performed in the second link in a period from a transmission time point of the response frame to a completion time point of a communication procedure initiated by the trigger frame.

The one or more instructions may be further executed to transmit, in the second link, an action frame including an identifier of the second STA that cannot perform a reception operation in the second link or information on a period in which the reception operation cannot be performed in the second link.

### Advantageous Effects

According to the present disclosure, in a wireless LAN system supporting a multi-link, a communication node (e.g., device, multi-link device (MLD), access point (AP), station (STA)) may perform direct communication based on a tunneled direct link setup (TDLS). Depending on the performance of the communication node, a period in which communication is impossible may occur. In this case, according to the exemplary embodiments of the present disclosure, errors in the direct communication can be prevented, and errors in the direct communication can be quickly recovered. Accordingly, a transmission reliability of frames can be improved, and a transmission delay of the frames can be reduced. That is, the performance of the wireless LAN system can be improved.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating an association procedure of a station in a wireless LAN system.

FIG. 5 is a timing diagram illustrating a first exemplary embodiment of an operation method of a communication node based on EDCA.

FIG. 6A is a timing diagram illustrating a first exemplary embodiment of a TDLS-based direct communication method in a wireless LAN system.

FIG. 6B is a timing diagram illustrating a second exemplary embodiment of a TDLS-based direct communication method in a wireless LAN system.

FIG. 7A is a block diagram illustrating a first exemplary embodiment of a TDLS data frame A used in the exemplary embodiments of FIGS. 6A and/or 6B.

FIG. 7B is a block diagram illustrating an encapsulated data frame used in the exemplary embodiment of FIGS. 6A and/or 6B.

FIG. 7C is a block diagram illustrating a first exemplary embodiment of a TDLS data frame B used in the exemplary embodiments of FIGS. 6A and/or 6B.

FIG. 8 is a timing diagram illustrating a third exemplary embodiment of a TDLS-based direct communication method in a wireless LAN system.

FIG. 9 is a timing diagram illustrating a fourth exemplary embodiment of a TDLS-based direct communication method in a wireless LAN system.

FIG. 10A is a timing diagram illustrating a fifth exemplary embodiment of a TDLS-based direct communication method in a wireless LAN system.

FIG. 10B is a timing diagram illustrating a sixth exemplary embodiment of a TDLS-based direct communication method in a wireless LAN system.

FIG. 10C is a timing diagram illustrating a seventh exemplary embodiment of a TDLS-based direct communication method in a wireless LAN system.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

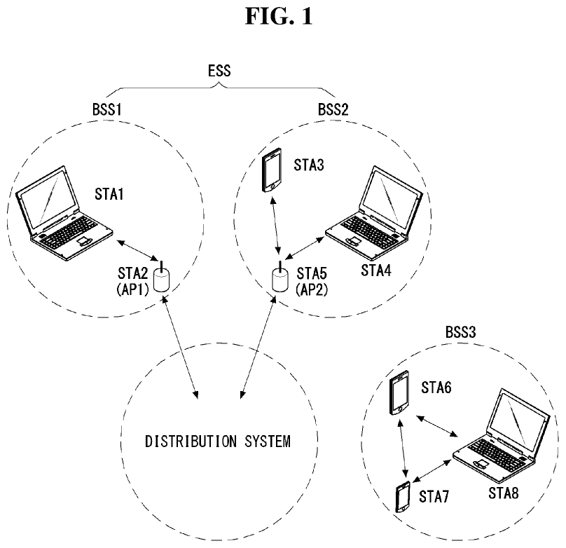

FIG. 1 is a conceptual diagram illustrating a first exemplary embodiment of a wireless LAN system.

Referring to FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

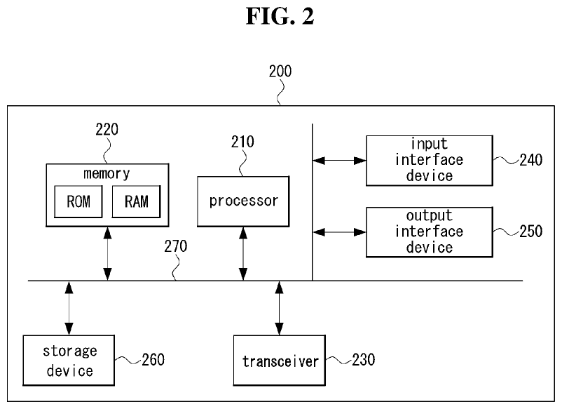

FIG. 2 is a block diagram illustrating a first exemplary embodiment of a communication node constituting a wireless LAN system.

Referring to FIG. 2, a communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

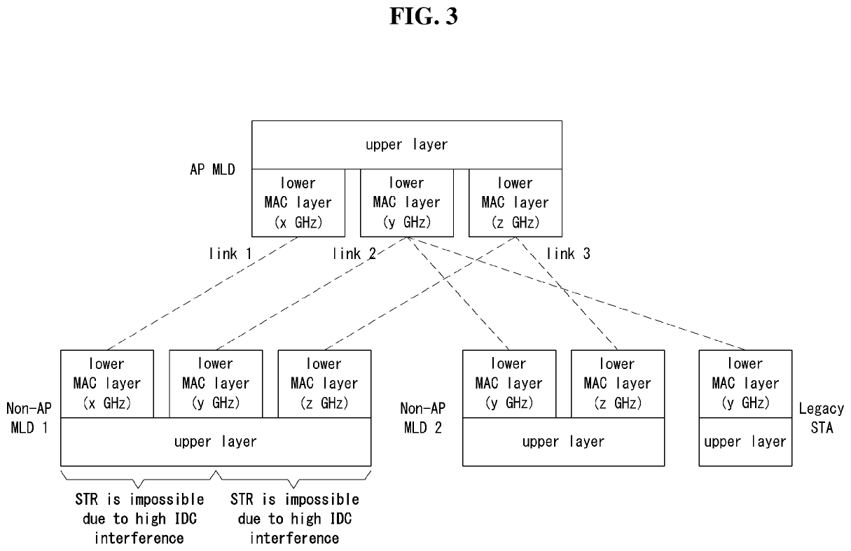

FIG. 3 is a conceptual diagram illustrating a first exemplary embodiment of a multi-link configured between multi-link devices (MLDs).

Referring to FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

Each of the AP MLD and the STA MLD may have an MLD MAC address, and each of the AP and the STA operating in each link may have a MAC address. The MLD MAC address of the AP MLD may be referred to as an AP MLD MAC address, and the MLD MAC address of the STA MLD may be referred to as a STA MLD MAC address. The MAC address of the AP may be referred to as an AP MAC address, and the MAC address of the STA may be referred to as a STA MAC address. In a multi-link negotiation procedure, the AP MLD MAC address and the STA MLD MAC address may be used. The address of the AP and the address of the STA may be exchanged and/or configured in the multi-link negotiation procedure.

When the multi-link negotiation procedure is completed, the AP MLD may generate an address table and manage and/or update the address table. One AP MLD MAC address may be mapped to one or more AP MAC addresses, and corresponding mapping information may be included in the address table. One STA MLD MAC address may be mapped to one or more STA MAC addresses, and corresponding mapping information may be included in the address table. The AP MLD may identify address information based on the address table. For example, when a STA MLD MAC address is received, the AP MLD may identify one or more STA MAC addresses mapped to the STA MLD MAC address based on the address table.

In addition, the STA MLD may manage and/or update the address table. The address table may include ‘mapping information between the AP MLD MAC address and the AP MAC address(es)’ and/or ‘mapping information between the STA MLD MAC address and the STA MAC address(es)’. The AP MLD may receive a packet from a network, identify an address of a STA MLD included in the packet, identify link(s) supported by the STA MLD, and may identify STA(s) taking charge of the link(s) from the address table. The AP MLD may set STA MAC address(es) of the identified STA(s) as a receiver address(es), and may generate and transmit frame(s) including the receiver address(es).

Meanwhile, an association procedure in a wireless LAN system may be performed as follows.

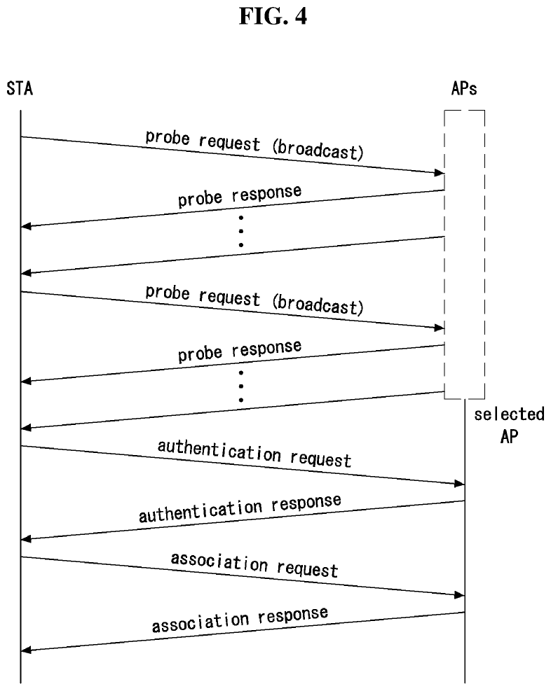

FIG. 4 is a sequence chart illustrating an association procedure of a station in a wireless LAN system.

Referring to FIG. 4, an association procedure of a STA in an infrastructure BSS may generally be divided into a probe step of detecting AP(s), an authentication step with detected AP(s), and an association step with the authenticated AP(s). The STA may be a STA MLD or a STA affiliated with the STA MLD, and the AP may be an AP MLD or an AP affiliated with the AP MLD.

The STA may detect neighboring APs using a passive scanning scheme or an active scanning scheme. When the passive scanning scheme is used, the STA may detect neighboring APs by overhearing beacons transmitted by APs. When the active scanning scheme is used, the STA may transmit a probe request frame, and may detect neighboring APs by receiving probe response frames that are responses to the probe request frame from the APs.

When the neighboring APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In this case, the STA may select one AP among AP(s) with which the STA has performed the authentication step, and perform the association step with the selected AP. That is, the STA may transmit an association request frame to the selected AP, and may complete the association with the selected AP by receiving an association response frame that is a response to the association request frame from the selected AP.

Meanwhile, communication nodes (e.g., access points, stations, and the like) belonging to the wireless LAN system may perform transmission and reception operations of frames based on a point coordination function (PCF), hybrid coordination function (HCF), HCF controlled channel access (HCCA), distributed coordination function (DCF), enhanced distributed channel access (EDCA), and/or the like.

In the wireless LAN system, frames may be classified into a management frame, a control frame, and a data frame. The management frame may include an association request frame, association response frame, reassociation request frame, reassociation response frame, probe request frame, probe response frame, beacon frame, disassociation frame, authentication frame, deauthentication frame, action frame, and the like.

The control frame may include an acknowledgment (ACK) frame, block ACK request (BAR) frame, block ACK (BA) frame, power saving (PS)-Poll frame, request-to-send (RTS) frame, clear-to-send (CTS) frame, and the like. The data frame may be classified into a quality of service (QOS) data frame and a non-QoS data frame. The QoS data frame may refer to a data frame for which transmission according to a QoS is required, and the non-QoS data frame may indicate a data frame for which transmission according to a QoS is not required.

Meanwhile, in a wireless LAN system, a communication node (e.g., access point or station) may operate based on the EDCA scheme.

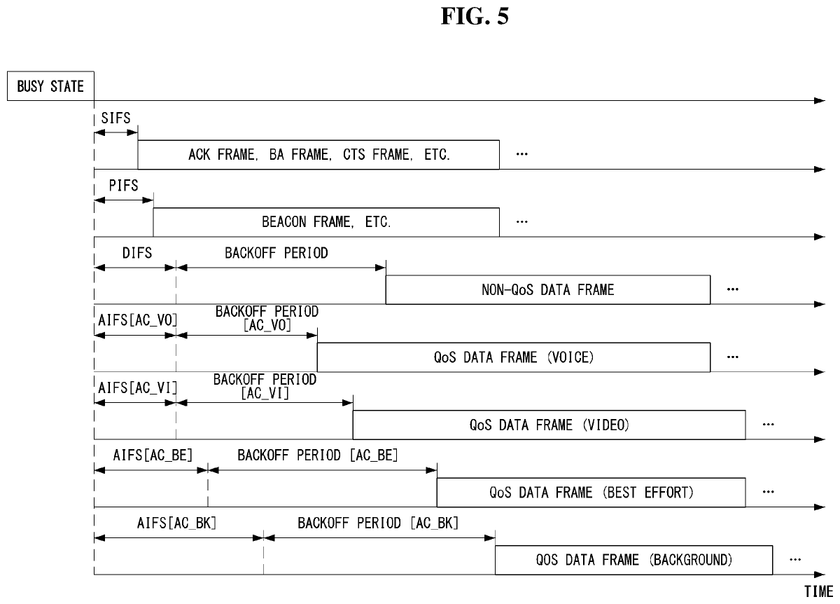

FIG. 5 is a timing diagram illustrating a first exemplary embodiment of an operation method of a communication node based on EDCA.

Referring to FIG. 5, a communication node desiring to transmit a control frame (or a management frame) may perform a channel state monitoring operation (e.g., carrier sensing operation) during a predetermined period (e.g., short interframe space (SIFS) or PCF IFS (PIFS)), and when the channel state is determined to be idle during the predetermined period (e.g., SIFS or PIFS), the communication node may transmit the control frame (or the management frame). For example, the communication node may transmit an ACK frame, a BA frame, a CTS frame, or the like when the channel state is determined to be idle during SIFS. Also, the communication node may transmit a beacon frame or the like when the channel state is determined to be idle during the PIFS. On the other hand, when it is determined that the channel state is busy during the predetermined period (e.g., SIFS or PIFS), the communication node may not transmit the control frame (or the management frame). Here, the carrier sensing operation may refer to a clear channel assessment (CCA) operation.

A communication node desiring to transmit a non-QoS data frame may perform a channel state monitoring operation (e.g., carrier sensing operation) during DCF IFS (DIFS), and when the channel state is determined to be idle during the DIFS, the communication node may perform a random backoff procedure. For example, the communication node may select a backoff value (e.g., a backoff counter) within a contention window according to the random backoff procedure and may perform a channel state monitoring operation (e.g., carrier sensing operation) during a period corresponding to the selected backoff value (hereinafter, referred to as ‘backoff period’). The communication node may transmit the non-QoS data frame when the channel state is determined to be idle in the backoff period.

A communication node desiring to transmit a QoS data frame may perform a channel state monitoring operation (e.g., carrier sensing operation) during an arbitration IFS (AIFS), and when the channel state is determined to be idle during the AIFS, the communication node may perform a random backoff procedure. The AIFS may be configured according to an access category (AC) of a data unit (e.g., protocol data unit (PDU)) included in the QoS data frame. The AC of the data unit may be as shown in Table 1 below.

TABLE 1

| Priority | AC | Description |
|---|---|---|
| Lowest | AC_BK | Background |
| | AC_BE | Best effort |
| Highest | AC_VI | Video |
| | AC_VO | Voice |

AC_BK may indicate background data, AC_BE may indicate data transmitted in the best effort manner, AC_VI may indicate video data, AC_VO may indicate voice data. For example, the length of the AIFS for the QoS data frame corresponding to each of AC_VO and AC_VI may be configured to be equal to the length of the DIFS. The length of the AIFS for the QoS data frame corresponding to each of AC_BE and AC_BK may be configured to be longer than the length of the DIFS. Here, the length of the AIFS for the QoS data frame corresponding to AC_BK may be configured to be longer than the length of the AIFS for the QoS data frame corresponding to AC_BE.

In the random backoff procedure, the communication node may select a backoff value (e.g., a backoff counter) within a contention window according to the AC of the QoS data frame. The contention window according to the AC may be as shown in Table 2 below. CWₘᵢₙ may indicate a minimum value of the contention window, CWₘₐₓ may indicate a maximum value of the contention window, and each of the minimum value and the maximum value of the contention window may be represented by the number of slots.

TABLE 2

| AC | CWₘᵢₙ | CWₘₐₓ |
|---|---|---|
| AC_BK | 31 | 1023 |
| AC_BE | 31 | 1023 |
| AC_VI | 15 | 31 |
| AC_VO | 7 | 15 |

The communication node may perform a channel state monitoring operation (e.g., carrier sensing operation) in the backoff period and may transmit the QoS data frame when the channel state is determined to be idle in the backoff period.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

Hereinafter, a wireless communication network to which exemplary embodiments according to the present disclosure are applied will be described. The wireless communication network to which exemplary embodiments according to the present disclosure are applied is not limited to the content described below, and exemplary embodiments according to the present disclosure may be applied to various wireless communication networks.

An MLD may perform direct communication based on a tunneled direct link setup (TDLS). In this case, a communication problem according to an enhanced multi-link single radio (EMLSR) operation, a communication problem according to an enhanced multi-link multi radio (EMLMR) operation, and/or a communication problem according to an NSTR operation may occur. Method(s) for solving the above-mentioned problem(s) will be proposed in exemplary embodiments below. The above-mentioned problem(s) can be solved through cooperation between multi-link operations and direct communications.

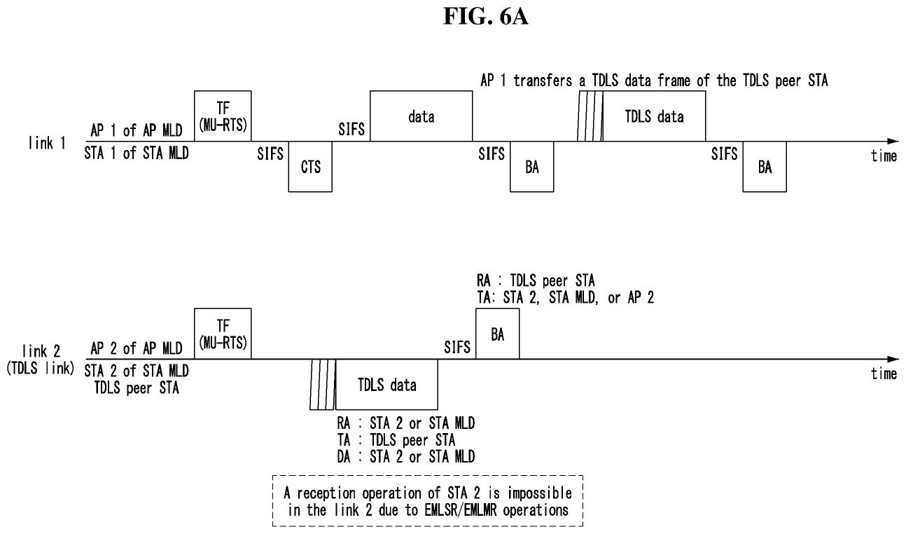

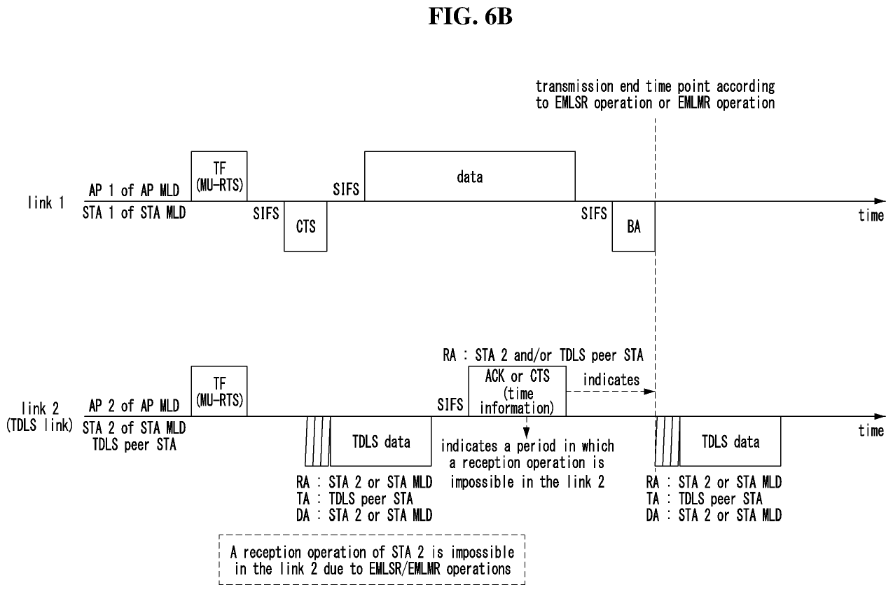

FIG. 6A is a timing diagram illustrating a first exemplary embodiment of a TDLS-based direct communication method in a wireless LAN system, and FIG. 6B is a timing diagram illustrating a second exemplary embodiment of a TDLS-based direct communication method in a wireless LAN system.

Referring to FIGS. 6A and 6B, in a TDLS-based direct communication procedure, an AP MLD may perform a relaying operation based on a tunneling scheme. The AP MLD may include one or more APs, and a STA MLD may include one or more STAs. An AP 1 of the AP MLD may operate in a link 1, and a STA 1 of the STA MLD may operate in the link 1. An AP 2 of the AP MLD may operate in a link 2, and a STA 2 of the STA MLD may operate in the link 2. The link 2 may be a TDLS link established between the STA MLD (e.g., STA 2) and a TDLS peer STA.

A direct communication procedure between terminals through the TDLS may be performed within a TXOP allocated by the AP MLD. For example, the direct communication procedure between terminals through the TDLS may be performed within a triggered TXOP sharing period allocated by the AP MLD using a trigger frame.

In order to support an EMLSR operation and/or EMLMR operation, the AP MLD may transmit a multi-user (MU)-request-to-send (RTS) frame or a buffer status report poll (BSRP) trigger frame in link(s) in which the STA MLD operates. A communication node supporting EMLSR operations may be referred to as an EMLSR device, EMLSR MLD, EMLSR AP, or EMLSR STA. A communication node supporting EMLMR operations may be referred to as an EMLMR device, EMLMR MLD, EMLMR AP, or EMLMR STA. The EMLSR MLD or EMLMR MLD may perform a data transmission/reception procedure initiated by a specific frame (e.g., MU-RTS frame or BSRP trigger frame). The data (e.g., frame) transmission/reception procedure may be referred to as a communication procedure. Each of the MU-RTS frame and the BSRP trigger frame may be a trigger frame used to initiate the data transmission/reception procedure (e.g., communication procedure). The trigger frame may be referred to as a TF.

The STA MLD may receive the MU-RTS frame or the BSRP trigger frame from the AP MLD, and may transmit a clear-to-send (CTS) frame to the AP MLD in response to the corresponding frame. The CTS frame may be a response frame to the trigger frame. The CTS frame may be transmitted in one link (e.g., link 1) among the links in which the STA MLD operates. After transmitting the CTS frame in the link 1, the STA MLD may transition a radio (e.g., radio receiver or radio transceiver) operating in the link 2 to the link 1. Accordingly, after transmission of the CTS frame in the link 1, the STA 2 of the STA MLD cannot receive a frame in the link 2 in which the CTS frame was not transmitted until the frame transmission/reception procedure (e.g., communication procedure) is completed in the link 1. A delay time (e.g., Delay 1) may be required to transition the radio operating in the link 2 to the link 1. Accordingly, the STA MLD may complete the operation of transitioning the radio within a short interframe space (SIFS) from a transmission time point of the CTS frame or within a padding time of the MU-RTS frame and/or the BSRP frame transmitted by the AP MLD.

In order to perform direct communication between the TDLS peer STA and the STA 2 of the STA MLD, a TDLS link may be established. A TDLS link setup procedure (e.g., TDLS setup procedure) may be performed in a specific link. For example, a TDLS link setup procedure for the link 2 may be performed, and the link 2 may be configured as a TDLS link. The TDLS peer STA may transmit a direct communication data frame (e.g., TDLS data frame) to the STA2 of the STA MLD in the link 2 (e.g., TDLS link). Since the AP MLD performs a listening operation in all the links, the AP MLD may know that the TDLS peer STA transmits the TDLS data frame in the link 2, that the STA MLD transitions the radio of the link 2 to the link 1 to perform the EMLSR operation or EMLMR operation, and/or that the STA MLD fails to receive the TDLS data frame in the link 2 due to the transition of the radio from the link 2. The TDLS data frame may mean a TDLS data unit, a TDLS physical layer protocol data unit (PPDU), and/or a TDLS MAC protocol data unit (MPDU). The data frame may mean a data unit, a PPDU, and/or an MPDU.

The AP MLD performing a listening operation in all the links may receive the TDLS data frame transmitted from the TDLS peer STA to the STA2 of the STA MLD, and may perform a decoding operation on the TDLS data frame. When the decoding operation on the TDLS data frame is completed without an error, the AP MLD may transmit a reception response frame (e.g., acknowledgment (ACK) frame or a block ACK (BA) frame) for the TDLS data frame to the TDLS peer STA instead of the STA 2 of the STA MLD. The reception response frame for the TDLS data frame may be transmitted in the link 2 (e.g., TDLS link).

When the TDLS data frame has a form of an aggregated (A)-MPDU and an error occurs for some MPDUs among a plurality of MPDUs included in the TDLS data frame, the AP MLD may request retransmission of data (e.g., MPDU in which an error occurs) by transmitting a reception response frame indicating that the error (e.g., negative ACK (NACK)) occurs. A transmitter address field included in the reception response frame transmitted by the AP MLD may be set to a MAC address of the STA2 affiliated with the STA MLD, a MAC address of the STA MLD, or a MAC address of the AP 2 affiliated with the AP MLD.

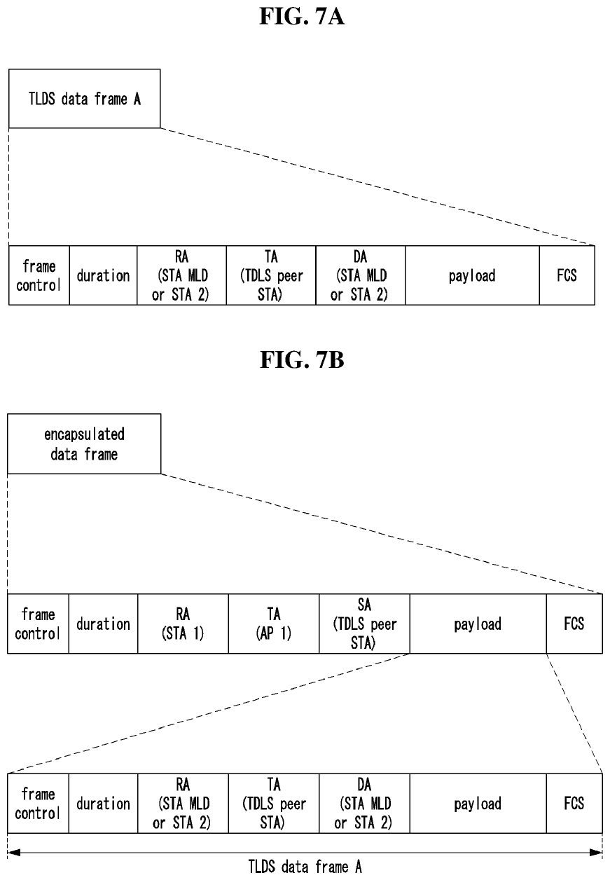

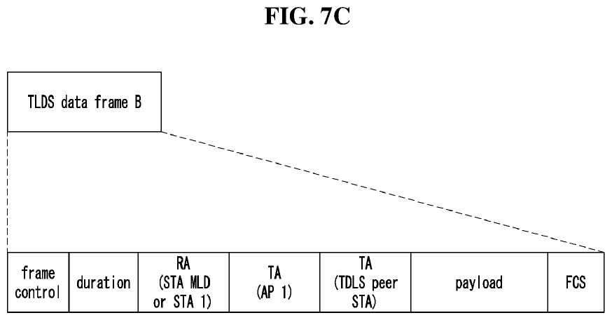

Since a destination of the TDLS data frame (e.g., TDLS data frame received without an error) is the STA 2 of the STA MLD, not the AP MLD, the AP MLD may store the TDLS data frame in its own buffer to transmit it to the STA 2 of the STA MLD, which is the destination. Since the STA MLD affiliated with the STA 2 operates in the link 1, the AP MLD may transmit the TDLS data frame to the STA MLD in the link 1. The TDLS data frame transmitted in the link 1 may have a frame format (e.g., tunneling frame format) shown in FIGS. 7A, 7B, and/or 7C. In the link 1, the TDLS data frame may be transmitted based on a tunneling scheme. The format of the TDLS data frame transmitted by the TDLS peer STA in the link 2 may be different from the format of the TDLS data frame transmitted by the AP MLD in the link 1.

In order to transmit the TDLS data frame based on the tunneling scheme, the AP MLD may perform a new channel access procedure (e.g., backoff procedure) after the data transmission/reception procedure is completed in the link 1. If the channel access procedure is successful, the AP MLD may transmit the TDLS data frame to the STA MLD in the link 1.

When the EMLSR operation or EMLMR operation is supported, in the data transmission/reception procedure initiated by the MU-RTS frame or the BSRP trigger frame, a data frame may be transmitted/received using multiple spatial streams. After the data transmission/reception procedure initiated by the MU-RTS frame or the BSRP trigger frame is completed, the EMLSR MLD (or EMLSR AP, EMLSR STA) or EMLMR MLD (or EMLMR AP, EMLMR STA) may transmit and receive a TDLS data frame using multiple spatial streams without transitioning its radio to the link 2. To support this operation, a MAC header of the data frame transmitted to the STA MLD in the data transmission/reception procedure initiated by the MU-RTS frame or the BSRP trigger frame may include information indicating not to transition the radio to the link 2. The above-described information may indicate that there is another data frame to be transmitted after the data frame. The above-described information may be a ‘more data’ field. The ‘more data’ field set to a first value (e.g., 1) may indicate not to transition the radio to the link 2. When it is identified that the ‘more data’ field included in the MAC header of the data frame is set to the first value, the EMLSR MLD (or EMLSR AP, EMLSR STA) or EMLMR MLD (or EMLMR AP, EMLMR STA) mat wait for reception of the data frame in the link 1 without transitioning the radio to the link 2.

When the MAC header of the data frame includes information indicating use of multiple spatial streams, the EMLSR MLD (or EMLSR AP, EMLSR STA) or EMLMR MLD (or EMLMR AP, EMLMR STA) may use a plurality of radios to receive the data frame (e.g., TDLS data frame) through multiple spatial streams. When a TDLS data frame does not exist in the buffer at the time of transmitting the data frame in the data transmission/reception procedure initiated by the MU-RTS frame or the BSRP trigger frame, the ‘more data’ field of the MAC header may be set to a second value (e.g., 0), and the data frame including the corresponding MAC header may be transmitted. When it is identified that the ‘more data’ field included in the MAC header of the data frame is set to the second value, after the data transmission/reception procedure initiated by the MU-RTS frame or BSRP trigger frame ends, the EMLSR MLD (or EMLSR AP, EMLSR STA) or EMLMR MLD (or EMLMR AP, EMLMR STA) may transition the radio to the link 2. A delay time (e.g., Delay2) may be required to transition the radio from the link 1 to the link 2.

When the ‘more data’ field included in the MAC header of the data frame transmitted by the AP MLD to the STA MLD is set to the second value, and a TDLS data frame to be transmitted to the STA MLD exists in the buffer of the AP MLD, the AP MLD may transmit the TDLS data frame to the STA MLD in the link 1 or 2 by using the data transmission/reception procedure initiated by the MU-RTS frame or BSRP trigger frame. The TDLS data frame may be transmitted/received based on a tunneling scheme.

The AP MLD may configure the TDLS peer STA not to transmit a frame (e.g., data frame) in the link 2 during a period (e.g., blindness period) in which the STA 2 of the STA MLD cannot receive in the link 2. A duration field of a specific frame (e.g., reception response frame, ACK frame, CTS frame) may be set to indicate a time point at which a transmission procedure based on the EMLSR or EMLMR operation is completed in the link 1 (e.g., a period in which a reception operation is impossible in the link 2), and the AP MLD may transmit the specific frame including the corresponding duration field to the STA MLD. A receiver address field included in the specific frame may be set to the address of the STA 2 affiliated with the STA MLD, and the specific frame may be transmitted in a unicast manner.

The period in which a reception operation is impossible in the link 2 may include a time required to transition the radio of the STA MLD to the link 2 after receiving a data frame in the data transmission/reception procedure initiated by the MU-RTS frame or BSRP trigger frame in the link 1. A destination of the frame including information indicating the period in which a reception operation of the STA MLD (e.g., STA 2) is impossible in the link 2 may be the TDLS peer STA. The TDLS peer STA may identify the period in which a reception operation of the STA MLD (e.g., STA 2) is impossible in the link 2 based on the information included in the frame received from the AP MLD, and during the period in which a reception operation is impossible in the link 2, may not perform direct communication with the STA 2.

In order to support the above-described operations, the AP MLD may use a TDLS quiet action frame. The TDLS quiet action frame may include information indicating the period in which a reception operation of the STA MLD (e.g., STA 2) is impossible in the link 2. A response to the TDLS quiet action frame may be unnecessary. In the link 2, a transmitter of the TDLS quiet action frame may be the AP 2 of the AP MLD or the STA 2 of the STA MLD. A duration field included in the TDLS quiet action frame may be set to 0. In this case, other STA(s) receiving the TDLS quiet action frame may not be able to set a network allocation vector (NAV). The TDLS quiet action frame may be transmitted in a broadcast manner. The TDLS quiet action frame may include information indicating the period in which a reception operation is impossible in the link 2 and/or an identifier of a STA (e.g., MAC address of the STA 2) that cannot perform a reception operation in the link 2. Since the STA MLD affiliated with the STA 2 performs a frame transmission/reception procedure in another link (e.g., link 1) based on an EMLSR or EMLMR operation, the STA 2 may not be able to perform a reception operation in the link 2.

A transmission time point of the TDLS quiet action frame in the link 2 may be synchronized with a transmission time point of the MU-RTS frame or the BSRP trigger frame in the link 1. That is, the AP MLD may simultaneously transmit the MU-RTS frame (or BSRP trigger frame) and the TDLS quiet action frame in multiple links. Alternatively, the AP MLD may transmit the TDLS quiet action frame to the TDLS peer STA after receiving the TDLS data frame in the link 2. The TDLS peer STA may receive the TDLS quiet action frame, and may determine that the STA MLD (e.g., STA2) can perform a reception operation in the link 2 after the period (e.g., the period in which a reception operation is impossible in the link 2 or the period in which a frame transmission/reception procedure according to the EMSLR or EMLMR operation is performed in the link 1) indicated by the TDLS quiet action frame ends. Accordingly, the TDLS peer STA may transmit a frame (e.g., data frame) by performing a new backoff operation in the link 2 after the period indicated by the TDLS quiet action frame ends.

The AP MLD may receive the TDLS data frame from the TDLS peer STA in the link 2, and in response to the TDLS data frame, may transmit the TDLS quiet action frame or a control frame (e.g., reception response frame, ACK frame, CTS frame) including information indicating the period in which a reception operation of the STA MLD (e.g., STA 2) is impossible in the link 2, instead of a reception response frame (e.g., BA frame). The TDLS peer STA may receive the TDLS quiet action frame or the control frame in response to the TDLS data frame, and based on the information included in the TDLS quiet action frame or control frame, may identify the period in which a reception operation of the STA MLD (e.g., STA 2) is impossible in the link 2, and may perform a new backoff operation to transmit a frame (e.g., data frame) after the identified period.

Alternatively, the backoff operation of the TDLS peer STA may be performed before an end time point of the period in which a reception operation of the STA MLD (e.g., STA 2) is impossible in the link 2, and the TDLS peer STA may transmit a frame when a value of a backoff counter according to the backoff operation becomes 0 after the end time point of the period in which a reception operation of the STA MLD (e.g., STA 2) is impossible in the link 2. If the value of the backoff counter according to the backoff operation becomes 0 before the end time point of the period in which a reception operation of the STA MLD (e.g., STA 2) is impossible in the link 2, the TDLS peer STA may perform a backoff operation again. In this case, EDCA parameter(s) for the backoff operation may be the same as EDCA parameter(s) used in the previous backoff operation. For example, the size of the contention window may not be doubled. That is, the size of the contention window in the new backoff operation may be the same as the size of the contention window in the previous backoff operation. Also, a backoff counter value in the new backoff operation may be the same as the backoff counter value in the previous backoff operation. That is, the backoff counter value may not be increased.

FIG. 7A is a block diagram illustrating a first exemplary embodiment of a TDLS data frame A used in the exemplary embodiments of FIGS. 6A and/or 6B, FIG. 7B is a block diagram illustrating an encapsulated data frame used in the exemplary embodiment of FIGS. 6A and/or 6B, and FIG. 7C is a block diagram illustrating a first exemplary embodiment of a TDLS data frame B used in the exemplary embodiments of FIGS. 6A and/or 6B.

Referring to FIGS. 7A to 7C, the TDLS data frame A may be a TDLS data frame transmitted by the TDLS peer STA, and the encapsulated data frame or the TDLS data frame B may be a TDLS data frame transmitted by the AP MLD (e.g., AP 1). The TDLS peer STA may transmit a TDLS data frame (e.g., TDLS data frame A) in the link 2. If a reception operation of the STA MLD (e.g., STA 2) is impossible in the link 2, the AP MLD may receive the TDLS data frame (e.g., TDLS data frame A) from the TDLS peer STA, and store the TDLS data frame A in the buffer. Thereafter, the AP MLD may generate an encapsulated data frame or TDLS data frame B based on the TDLS data frame A, and may transmit the encapsulated data frame or TDLS data frame B to the STA MLD in the link 1. The encapsulated data frame may include the TDLS data frame A, and the TDLS data frame B may be a modified form of the TDLS data frame A.

The TDLS data frame A may include a MAC header, a payload, and a frame check sequence (FCS) field. The MAC header of the TDLS data frame A may include a frame control field, a duration field, a receiver address (RA) field, a transmitter address (TA) field, and a destination address (DA) field. The payload of the TDLS data frame A may include a data unit (e.g., TDLS data unit). The address fields included in the MAC header of the TDLS data frame may be set as shown in Table 3 below. In Table 3 below, the addresses may be MAC addresses.

TABLE 3

| | Description |
|---|---|
| RA field | Address of the STA MLD or the STA 2 |
| TA field | Address of the TDLS peer STA |
| DA field | Address of the STA MLD or the STA2 |

The encapsulated data frame may include a MAC header, a payload, and an FCS field. The MAC header of the encapsulated data frame may include a frame control field, a duration field, an RA field, a TA field, and a source address (SA) field. The payload of the encapsulated data frame may include the TDLS data frame A stored in the buffer of the AP MLD instead of a data unit of the AP MLD. That is, the unmodified TDLS data frame A may be included in the encapsulated data frame. The encapsulated data frame (e.g., TDLS data frame A) may be transmitted in a tunneling scheme. The address fields included in the MAC header of the encapsulated data frame may be set as shown in Table 4 below. In Table 4 below, the addresses may be MAC addresses.

TABLE 4

| | Description |
|---|---|
| RA field | Address of the STA 1 |
| TA field | Address of the AP1 |
| DA field | Address of the TDLS peer STA |

The TDLS data frame B may include a MAC header, a payload, and an FCS field. The MAC header of the TDLS data frame B may include a frame control field, a duration field, an RA field, a TA field, and an SA field. The TDLS data frame B may not be in a tunneling frame format. The RA field, the TA field, and/or the DA field included in the TDLS data frame B may indicate that the corresponding TDLS data frame B includes a tunneled data unit (e.g., TDLS data unit). The payload of the TDLS data frame B may include a data unit (e.g., TDLS data unit) stored in the buffer of the AP MLD. The payload of the TDLS data frame B may be the same as the payload of the TDLS data frame A. The FCS field may be used to check whether there is an error in the data, and may be set to a value for the TDLS data frame B. The address fields included in the MAC header of the TDLS data frame B may be set as shown in Table 5 below. In Table 5 below, the addresses may be MAC addresses.

TABLE 5

| | Description |
|---|---|
| RA field | Address of the STA 1 or the STA MLD |
| TA field | Address of the AP 1 |
| DA field | Address of the TDLS peer STA |

The above-described exemplary embodiments may be applied to a case in which a reception operation in a specific link is impossible due to an EMLSR operation, a case in which a reception operation in a specific link is impossible due to an EMLMR operation, and/or a case in which a reception operation in a specific link is impossible due to an NSTR problem caused by self-interference.

While a STA MLD (e.g., NSTR STA MLD), which is a device that does not support STR operations, performs a transmission operation in the link 1, the TDLS peer STA may perform a transmission operation in the link 2. In this case, a blindness period in which the STA MLD cannot perform a reception operation in the link 2 while performing the transmission operation in the link 1 may occur. A period in which the transmission operation is performed in the link 1 may be a blindness period in the link 2. Therefore, the STA MLD may not receive the TDLS data frame transmitted by the TDLS peer STA in the link 2. In this case, the communication nodes may operate based on the exemplary embodiments applied to the case in which a reception operation is impossible in a specific link due to an EMLSR operation and/or the case in which a reception operation is impossible in a specific link due to an EMLMR operation.

In the exemplary embodiments applied to the case in which a reception operation is impossible in a specific link due to an EMLSR operation and/or the case in which a reception operation is impossible in a specific link due to an EMLMR operation, the period in which a reception operation is impossible in the link 2 may be set in consideration of a time (e.g., delay time) required for transitioning the radio to the link 2 after completion of the frame transmission/reception procedure in the link 1. In the exemplary embodiments applied to the case in which a reception operation in a specific link is impossible due to an NSTR problem caused by self-interference, since the blindness period also ends when the frame transmission/reception procedure is completed in the link 1, the STA MLD may perform a reception operation in the link 2 immediately after the frame transmission/reception procedure is completed in the link 1.

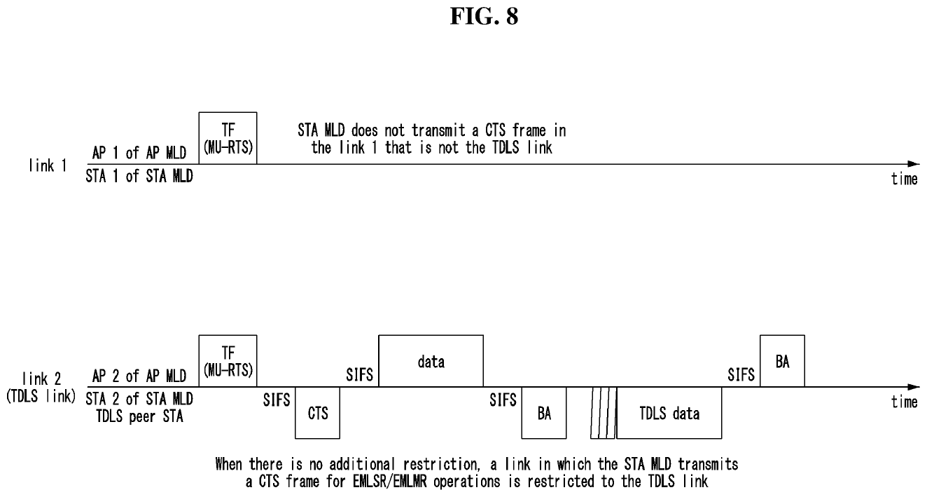

FIG. 8 is a timing diagram illustrating a third exemplary embodiment of a TDLS-based direct communication method in a wireless LAN system.

Referring to FIG. 8, a method of transmitting a CTS frame for preventing errors in the TDLS-based direct communication may be defined. The AP MLD may include one or more APs, and the STA MLD may include one or more STAs. The AP 1 of the AP MLD may operate in the link 1, and the STA 1 of the STA MLD may operate in the link 1. The AP 2 of the AP MLD may operate in the link 2, and the STA 2 of the STA MLD may operate in the link 2. The link 2 may be a TDLS link established between the STA MLD (e.g., STA 2) and a TDLS peer STA.

A direct communication procedure between terminals through the TDLS may be performed within a TXOP allocated by the AP MLD. For example, the direct communication procedure between terminals through the TDLS may be performed within a triggered TXOP sharing period allocated by the AP MLD using a trigger frame.

An EMLSR MLD or EMLMR MLD may perform a data transmission/reception procedure (e.g., communication procedure) initiated by a specific frame (e.g., MU-RTS frame or BSRP trigger frame). The AP MLD may transmit an MU-RTS frame or a BSRP trigger frame in one link or simultaneously in several links among links in which the STA MLD operates to perform an EMLSR operation or an EMLMR operation. The STA MLD may receive the MU-RTS frame or BSRP trigger frame from the AP MLD, and may transmit a CTS frame to the AP MLD in response to the frame. The CTS frame may be transmitted through one link (e.g., link 1) among the links in which the STA MLD operates. After transmitting the CTS frame in the link 1, the STA MLD may transition a radio (e.g., radio receiver or radio transceiver) operating in the link 2 to the link 1. Accordingly, after transmission of the CTS frame in the link 1, the STA 2 of the STA MLD cannot receive a frame in the link 2 in which the CTS frame was not transmitted until the frame (e.g., data) transmission/reception procedure is completed in the link 1.

The STA MLD may transmit the CTS frame in the TDLS link (e.g., link 2) based on TDLS configuration information with the TDLS peer STA. Prior to transmission of a TDLS data frame in the TDLS link, the TDLS peer STA may set a NAV for the TDLS link based on information obtained in the transmission/reception procedure of the MU-RTS frame and the CTS frame. After a transmission operation based on the EMLSR operation or EMLMR operation is completed, the TDLS peer STA may transmit the TDLS data frame to the STA MLD by performing a backoff operation.

When the STA 2 of the STA MLD cannot use the link 2 as another STA, which is a hidden node for the AP 2, occupies a channel, the STA MLD may transmit a CTS frame that is a response to the MU-RTS frame in another link (e.g., link 1) instead of the TDLS link (e.g., link 2).

According to a usage state of each link in which the AP MLD and/or the STA MLD operate, the TDLS link may be in a busy state. Therefore, when the AP MLD transmits the MU-RTS frame in a link (e.g., link 1) other than the TDLS link (e.g. link 2) or when the AP MLD transmits the MU-RTS frame in multiple links including the TDLS link and the TDLS link is in a busy state, the STA MLD may transmit a CTS frame that is a response to the MU-RTS frame in the link 1 rather than the TDLS link, and may receive a data frame based on the EMLSR operation or EMLMR operation.

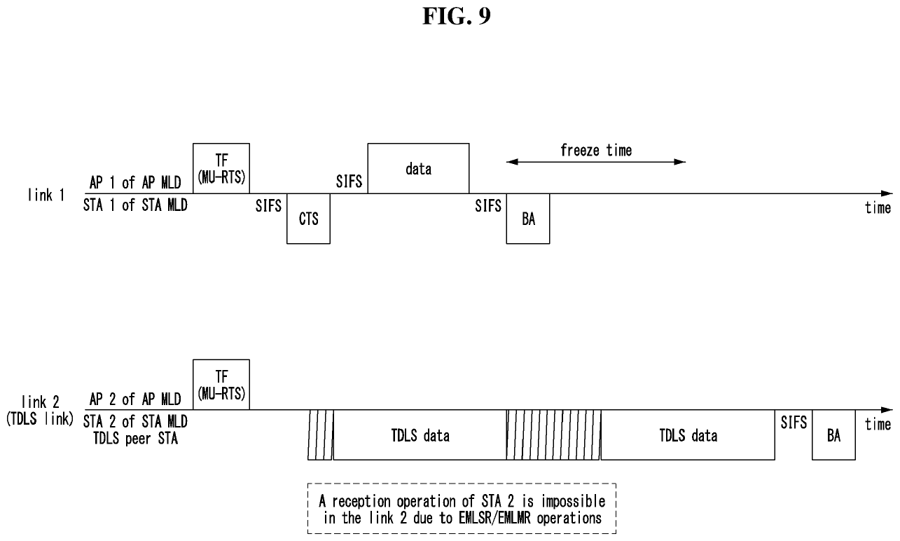

FIG. 9 is a timing diagram illustrating a fourth exemplary embodiment of a TDLS-based direct communication method in a wireless LAN system.

Referring to FIG. 9, a method of transmitting an MU-RTS frame or a BSRP trigger frame for preventing errors in the TDLS-based direct communication may be defined. When the AP MLD cannot decode a frame or when a destination is not the AP, the AP (e.g., AP MLD) may not transmit a reception response frame for the TDLS data frame. When the AP MLD does not transmit a reception response frame for the TDLS data frame, the AP MLD may perform a protection procedure according to exemplary embodiment below.

A direct communication procedure between terminals through the TDLS may be performed within a TXOP allocated by the AP MLD. For example, the direct communication procedure between terminals through the TDLS may be performed within a triggered TXOP sharing period allocated by the AP MLD using a trigger frame.

The AP MLD may include one or more APs, and the STA MLD may include one or more STAs. The AP 1 of the AP MLD may operate in the link 1, and the STA 1 of the STA MLD may operate in the link 1. The AP 2 of the AP MLD may operate in the link 2, and the STA 2 of the STA MLD may operate in the link 2. The link 2 may be a TDLS link established between the STA MLD (e.g., STA 2) and a TDLS peer STA.

An EMLSR MLD or EMLMR MLD may perform a data transmission/reception procedure (e.g., communication procedure) initiated by a specific frame (e.g., MU-RTS frame or BSRP trigger frame). The AP MLD may transmit a MU-RTS frame or a BSRP trigger frame in one link or simultaneously in several links among links in which the STA MLD operates to perform an EMLSR operation or an EMLMR operation. The STA MLD may receive the MU-RTS frame or BSRP trigger frame from the AP MLD, and may transmit a CTS frame to the AP MLD in response to the frame. The CTS frame may be transmitted through one link (e.g., link 1) among the links in which the STA MLD operates. After transmitting the CTS frame in the link 1, the STA MLD may transition a radio (e.g., radio receiver or radio transceiver) operating in the link 2 to the link 1. Accordingly, after transmission of the CTS frame in the link 1, the STA 2 of the STA MLD cannot receive a frame in the link 2 in which the CTS frame was not transmitted until the frame (e.g., data) transmission/reception procedure is completed in the link 1. A delay time (e.g., Delay1) may be required to transition the radio operating in the link 2 to the link 1. Accordingly, the STA MLD may complete the operation of transitioning the radio within a SIFS from a transmission time point of the CTS frame or within a padding time of the MU-RTS frame and/or the BSRP frame transmitted by the AP MLD.

An initiating STA that intends to perform direct communication may transmit a TDLS discovery request frame to the AP to discover a peer STA that is a target of the direct communication. The AP may receive the TDLS discovery request frame from the initiating STA, and may transmit the TDLS discovery request frame to all STAs in a broadcast manner. A peer STA may receive the TDLS discovery request frame from the AP. That is, the TDLS discovery request frame of the initiating STA may be transmitted to the peer STA via the AP. The peer STA may transmit a TDLS discovery response frame to the initiating STA in a unicast manner in response to the TDLS discovery request frame. The TDLS discovery response frame of the peer STA may be transmitted to the initiating STA via the AP. The above-described procedure may be a TDLS setup procedure, and in the TDLS setup procedure, the frames may be transmitted to each STA via the AP.

Accordingly, the AP MLD may identify TDLS configuration information between the STAs in the TDLS setup procedure. That is, the AP MLD may identify the TDLS link and the STAs performing direct communication in the TDLS link. For example, the AP MLD may identify that the direct communication between the STA 2 of the STA MLD and the TDLS peer STA is performed in the link 2 (e.g., TDLS link) by checking the frames transmitted and received in the TDLS link procedure.

While a frame transmission/reception procedure (e.g., communication procedure) between the AP MLD and the STA MLD based on the EMLSR or EMLMR operation is performed in the link 1, the AP 2 of the AP MLD may listen the TDLS data frame that the TDLS peer STA transmits to the STA 2 of the STA MLD. While the STA MLD performs a frame transmission/reception procedure based on the EMLSR operation or EMLMR operation in the link 1, the radio of the STA MLD may be in a state transitioned from the link 2 to the link 1. Accordingly, the STA MLD cannot perform a channel sensing operation and/or a frame reception operation in the link 2. In this case, the STA MLD cannot receive the TDLS data frame transmitted by the TDLS peer STA to the STA 2 of the STA MLD in the link 2.

Since the STA 2 of the STA MLD does not receive the TDLS data frame from the TDLS peer STA, it cannot transmit a reception response frame (e.g., BA frame) for the TDLS data frame. If a reception response frame (e.g., BA frame) is not received from the STA 2 of the STA MLD after a SIFS from a transmission time point of the TDLS data frame, the TDLS peer STA may determine that the transmission of the TDLS data frame fails. If transmission of the TDLS data frame fails, the TDLS peer STA may perform a backoff operation again to retransmit the TDLS data frame. In this case, since the backoff operation is performed again due to the transmission failure of the TDLS data frame, EDCA parameter(s) used in the backoff operation for retransmission may be doubled parameters from EDCA parameter(s) of the previous backoff operation (e.g., backoff operation for initial transmission). If the backoff operation for retransmission is successful, the TDLS peer STA may transmit the TDLS data frame stored in the buffer (e.g., TDLS data frame that has failed to be transmitted).

The AP 2 of the AP MLD may receive the TDLS data frame by performing a listening operation in the link 2. In addition, the AP 2 of the AP MLD may know that the STA 2 of the STA MLD cannot transmit a reception response frame (e.g., BA frame) for the TDLS data frame in the link 2 and/or that the TDLS peer STA performs a backoff operation to retransmit the TDLS data frame that has failed to be transmitted. If the STA MLD transitions the radio to the link 2 before the TDLS data frame retransmission procedure is initiated, the TDLS data frame retransmission procedure may succeed. In order for the STA MLD to transition the radio to the link 2, the AP MLD may not initiate a transmission/reception procedure of a new frame after the frame transmission/reception procedure is completed in the link 1. A transmission/reception procedure of a new frame may be initiated by a specific frame (e.g., MU-RTS frame or BSRP trigger frame) based on EMLSR operation or EMLMR operation. That is, the AP 1 of the AP MLD may not transmit an MU-RTS frame or a BSRP trigger frame for initiating a transmission/reception procedure of a frame using multiple spatial streams in the link for a preset time.

In order to support the above operations, in the frame transmission/reception procedure based on the EMLSR operation or EMLMR operation in the link 1, the AP 1 of the AP MLD may set a ‘more data’ field included in a MAC header of the last data frame to the STA 1 of the STA MLD to a second value (e.g., 0), and transmit the data frame including the corresponding more data field. A time in which the MU-RTS frame or the BSRP trigger frame is not transmitted may be referred to as a ‘freeze time’ or ‘EMLMR/EMLSR freeze time’. The AP MLD (e.g., AP 1 and/or AP 2) may set the freeze time in consideration of a transmission end time point of the TDLS data frame. The freeze time may be set based on the maximum backoff time aCWmax×aSlotTime. When the TDLS data frame is retransmitted twice, the freeze time may be set to the maximum value of the backoff counter used in the first retransmission procedure. Alternatively, the EMLMR/EMLSR freeze time may be regarded as a time when there is no data to be transmitted to the STA MLD in the link 1. During the corresponding time, the AP MLD may transmit a frame to a STA other than the EMLSR STA.

The freeze time may be early terminated when the TDLS data frame is normally detected or when a reception response frame of the STA MLD for the TDLS data frame is normally detected in the link 2. While the STA 2 of the STA MLD performs a reception operation of the TDLS data frame in the link 2 (e.g., during a TXOP configured for transmission of the TDLS data frame in the link 2), the AP MLD may not perform a frame transmission/reception procedure (e.g., a frame transmission/reception procedure based on an EMLSR operation or EMLMR operation) using multiple spatial streams with the STA MLD.

The AP MLD may not transmit an MU-RTS frame or a BSRP trigger frame to the STA MLD in a link (e.g., link 1) other than the TDLS link during the freeze time. The STA MLD may transition the radio to the link 2 during the freeze time. Accordingly, the STA MLD may receive the TDLS data frame from the TDLS peer STA in the link 2. Even though the TDLS peer STA performs a TDLS data frame retransmission procedure in the link 2, if the AP MLD initiates a frame transmission/reception procedure based on an EMLSR operation or EMLMR operation in the link 1, the STA 2 of the STA MLD cannot receive the TDLS data frame in the link 2. That is, (re)transmission of the TDLS data frame may continuously fail. In order to prevent (re)transmission of the TDLS data frame from continuing to fail, the AP MLD may configure the STA 2 of the STA MLD to perform a listening operation at a time when the TDLS peer STA is expected to perform the retransmission procedure.

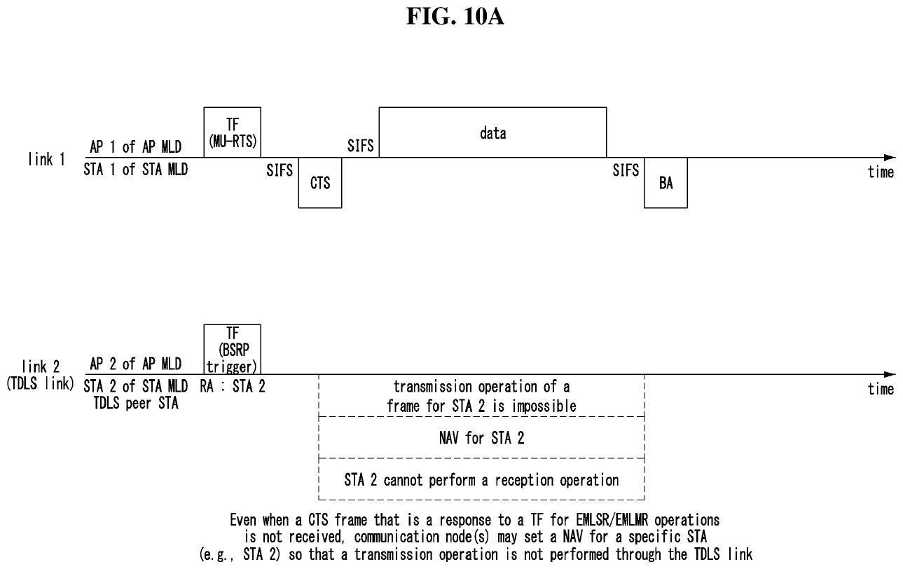

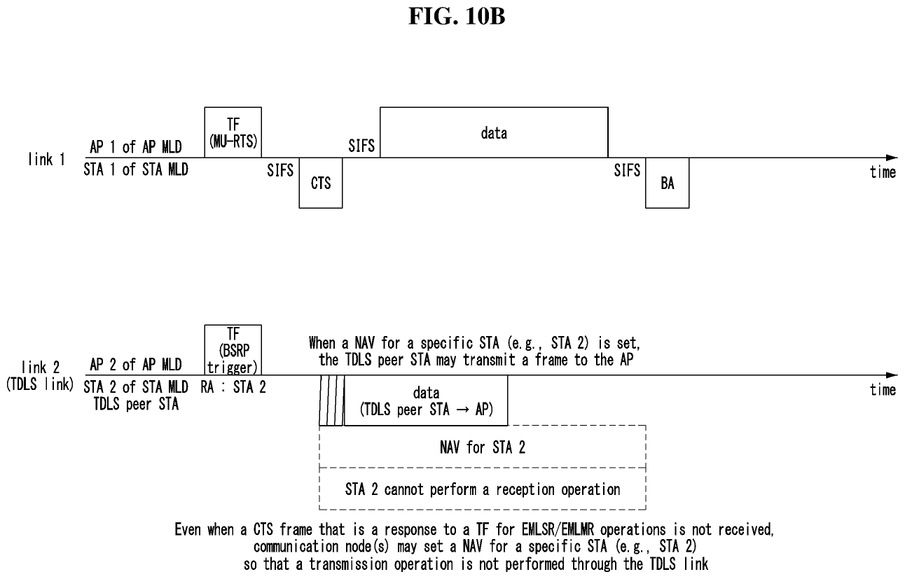

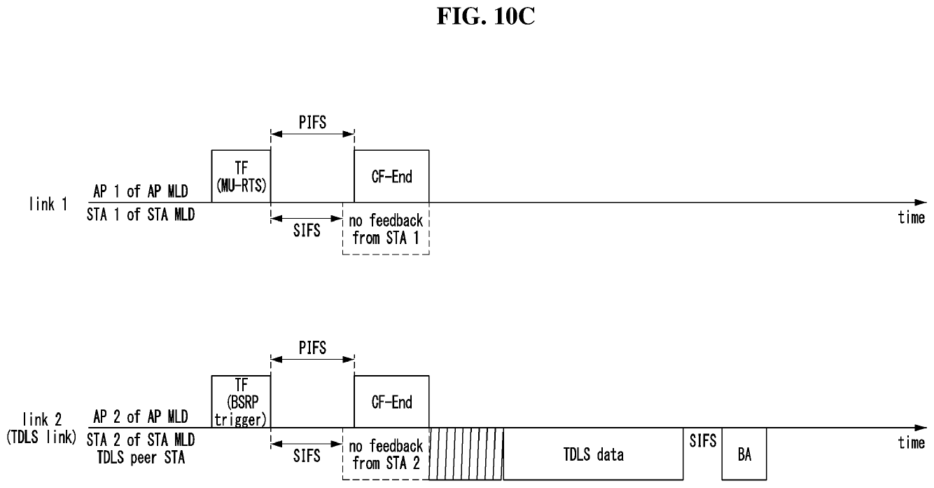

FIG. 10A is a timing diagram illustrating a fifth exemplary embodiment of a TDLS-based direct communication method in a wireless LAN system.

Referring to FIG. 10A, a method of setting a NAV for preventing errors in the TDLS-based direct communication may be defined. The AP MLD may include one or more APs, and the STA MLD may include one or more STAs. The AP 1 of the AP MLD may operate in the link 1, and the STA 1 of the STA MLD may operate in the link 1. The AP 2 of the AP MLD may operate in the link 2, and the STA 2 of the STA MLD may operate in the link 2. The link 2 may be a TDLS link established between the STA MLD (e.g., STA 2) and a TDLS peer STA.

A direct communication procedure between terminals through the TDLS may be performed within a TXOP allocated by the AP MLD. For example, the direct communication procedure between terminals through the TDLS may be performed within a triggered TXOP sharing period allocated by the AP MLD using a trigger frame.

In order to perform an EMLSR operation or EMLMR operation, the AP MLD may transmit an MU-RTS frame in the link 1 among multiple links in which the STA MLD operates, and may transmit a BSRP trigger frame in the link 2 among the multiple links in which the STA MLD operates. An RA field of the MU-RTS frame transmitted in the link 1 may be set to a broadcast address or a unicast address. That is, the MU-RTS frame may be transmitted in a broadcast manner or a unicast manner. An RA field (e.g., unicast address) of the BSRP trigger frame transmitted in the link 2 may be set to the MAC address of the STA 2. That is, the BSRP trigger frame or the MU-RTS frame of the link 2 may be transmitted in a unicast manner.

The AP MLD may transmit a TDLS quiet action frame in the link 2 instead of the BSRP trigger frame or the MU-RTS frame. An RA field of the TDLS quiet action frame may be set to the MAC address of the STA 2. The STA 1 of the STA MLD may receive the MU-RTS frame in the link 1, and identify whether an AID of the STA 1 exists among association IDs (AIDs) indicated by a ‘user information’ field of the MU-RTS frame. If the AID of STA 1 exists among the AIDs indicated by the user information field of the MU-RTS frame, the STA 1 may transmit a CTS frame after a SIFS from a reception time point of the MU-RTS frame. The CTS frame may be transmitted in the link (e.g., link 1) in which the MU-RTS frame is received.

Upon receiving the MU-RTS frame, the STA MLD may initiate an EMLSR operation or an EMLMR operation. That is, the EMLSR operation or the EMLMR operation of the STA MLD may be initiated by reception of the MU-RTS frame. To initiate the EMLSR operation or the EMLMR operation, the STA MLD may transmit a CTS frame, and may transition a radio operating in the link 2 to the link 1 within a SIFS from a transmission time point of the CTS frame or within a padding time of the MU-RTS frame and/or the BSRP frame transmitted by the AP MLD. The AP MLD may receive the CTS frame from the STA MLD, and may transmit a data frame using multiple spatial streams after a SIFS from a reception time point of the CTS frame. The STA MLD may receive the data frame from the AP MLD. Since the radio of the STA MLD has transitioned from the link 2 in which the CTS frame was not transmitted to the link 1, the STA 2 of the STA MLD cannot perform a channel sensing operation and/or reception operation in the link 2.

The TDLS peer STA may receive the BSRP trigger frame or the MU-RTS trigger frame from the AP MLD in the link 2. Even when a CTS frame is not received after a SIFS from a reception time point of the BSRP trigger frame or the MU-RTS trigger frame, the TDLS peer STA may set a NAV for the STA 2 of the STA MLD. If an address indicated by the RA field of the CTS frame is not the address of the TDLS peer STA (e.g., if a destination of the CTS frame is not the TDLS peer STA), the corresponding TDLS peer STA may set a NAV so that a transmission operation is not performed during a period indicated by a duration field included in a MAC header of the CTS frame.

Upon receiving the BSRP frame or MU-RTS trigger frame, the TDLS peer STA may set a NAV so that a transmission operation for the communication node having the address (e.g., MAC address) indicated by the RA field of the BSRP trigger frame is not performed. When the NAV for the destination of the TDLS data frame to be transmitted by the TDLS peer STA is set, the TDLS peer STA may not transmit the TDLS data frame until the corresponding NAV expires. The time indicated by the duration field included in the MAC header of the BSRP trigger frame may be set to include a time (e.g., Delay2) required for the radio of the STA MLD to transition to the link 2.

A trigger frame other than the BSRP trigger frame may also perform the above-described function and/or operation. When another trigger frame is transmitted to set a NAV, an RA field of the trigger frame may be set to a broadcast address, and the trigger frame may not be transmitted only to a communication node indicated by a user information field. Since the user information field includes an AID, the trigger frame may include a MAC address corresponding to the AID as additional information.

FIG. 10B is a timing diagram illustrating a sixth exemplary embodiment of a TDLS-based direct communication method in a wireless LAN system.

Referring to FIG. 10B, the AP MLD may include one or more APs, and the STA MLD may include one or more STAs. The AP 1 of the AP MLD may operate in the link 1, and the STA 1 of the STA MLD may operate in the link 1. The AP 2 of the AP MLD may operate in the link 2, and the STA 2 of the STA MLD may operate in the link 2. The link 2 may be a TDLS link established between the STA MLD (e.g., STA 2) and a TDLS peer STA.

A direct communication procedure between terminals through the TDLS may be performed within a TXOP allocated by the AP MLD. For example, the direct communication procedure between terminals through the TDLS may be performed within a triggered TXOP sharing period allocated by the AP MLD using a trigger frame.

A NAV set by a BSRP trigger frame or MU-RTS trigger frame transmitted in the link 2 may be used to configure a period in which a transmission operation is not performed for a communication node (e.g., STA 2) indicated by an RA field of the BSRP trigger frame. Accordingly, a transmission operation for a communication node (e.g., AP 2) other than the STA 2, which is a setting target of the NAV, may be performed in the period corresponding to the NAV.

FIG. 10C is a timing diagram illustrating a seventh exemplary embodiment of a TDLS-based direct communication method in a wireless LAN system.

Referring to FIG. 10C, the AP MLD may include one or more APs, and the STA MLD may include one or more STAs. The AP 1 of the AP MLD may operate in the link 1, and the STA 1 of the STA MLD may operate in the link 1. The AP 2 of the AP MLD may operate in the link 2, and the STA 2 of the STA MLD may operate in the link 2. The link 2 may be a TDLS link established between the STA MLD (e.g., STA 2) and a TDLS peer STA.

A direct communication procedure between terminals through the TDLS may be performed within a TXOP allocated by the AP MLD. For example, the direct communication procedure between terminals through the TDLS may be performed within a triggered TXOP sharing period allocated by the AP MLD using a trigger frame.

The AP MLD may transmit an MU-RTS frame or a BSRP trigger frame. If a response to the MU-RTS frame or the BSRP trigger frame is not received, the AP MLD may transmit a CF-End frame for terminating the communication procedure. When a CTS frame that is a response to the MU-RTS frame is not received from the STA 1 of the STA MLD in the link 1, the AP MLD may determine that the STA MLD does not perform an EMLSR operation or an EMLMR operation. In this case, a NAV for preventing a transmission operation for a specific communication node in the link 2 may not be set, and the AP MLD may transmit a CF-End frame in order not to set an unnecessary NAV.

If a CTS frame is not received in the link 1 after a SIFS from a transmission time point of the MU-RTS frame, the AP MLD may transmit a CF-End frame or another frame (e.g., a QoS Null frame including a duration field set to 0) in the link 2 after a PIFS (i.e., PCF IFS) or a (SIFS+additional time) from a transmission time point of the BSRP trigger frame, so that the TDLS peer STA does not set an unnecessary NAV by the BSRP trigger frame. The (SIFS+additional time) may be greater than or equal to a SIFS and less than or equal to a PIFS. Upon receiving the CF-End frame or another frame (e.g., QoS Null frame), the TDLS peer STA may perform a channel contention procedure, and when the channel contention procedure is successful, may transmit a TDLS data frame to the STA 2 of the STA MLD. That is, when the CF-End frame or another frame (e.g., QoS Null frame) is received, the TDLS peer STA may not set a NAV based on the BSRP trigger frame.

The exemplary embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those who are skilled in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. A method of an access point (AP) multi-link device (MLD), comprising:
transmitting a trigger frame in a multi-link, the multi-link including a first link and a second link;
receiving, from a first station (STA) affiliated with a STA MLD, a response frame to the trigger frame in the first link;
receiving, from a third STA, a first data frame in the second link; and
when a destination of the first data frame is a second STA affiliated with the STA MLD, transmitting a second data frame generated based on the first data frame to the first STA in the first link,
wherein the second link is a link established for direct communication between the second STA and the third STA.

2. The method according to claim 1, further comprising performing a communication procedure initiated by the trigger frame with the first STA in the first link, wherein the second data frame is transmitted based on a tunneling scheme after completion of the communication procedure.

3. The method according to claim 2, wherein a data frame transmitted from the AP MLD to the first STA in the communication procedure includes a ‘more data’ field, and the ‘more data’ field is set to indicate that the second data frame is transmitted after the data frame.

4. The method according to claim 1, further comprising transmitting, to the third STA, a reception response frame to the first data frame in the second link, wherein a duration field included in the reception response frame is set to indicate a completion time point of a communication procedure initiated by the trigger frame.

5. The method according to claim 1, wherein a reception operation of the second STA affiliated with the STA MLD is determined not to be performed in the second link in a period from a transmission time point of the response frame to a completion time point of a communication procedure initiated by the trigger frame.

6. The method according to claim 5, further comprising transmitting, in the second link, an action frame including an identifier of the second STA that cannot perform a reception operation in the second link or information on a period in which the reception operation cannot be performed in the second link.

7. The method according to claim 1, wherein the second data frame includes a medium access control (MAC) header, a payload, and a frame check sequence (FCS) field, and the payload includes the first data frame.

8. The method according to claim 1, wherein the second data frame includes a MAC header, a payload, and an FCS field, the MAC header includes a receiver address (RA) field, a transmitter address (TA) field, and a source address (SA) field, the RA field is set to an address of the STA MLD or the first STA, the TA field is set to an address of a first AP affiliated with the AP MLD, the SA field is set to an address of the third STA, and the payload included in the second data frame is identical to a payload included in the first data frame.

9. The method according to claim 1, wherein when an enhanced multi-link single radio (EMLSR) operation or an enhanced multi-link multi radio (EMLMR) operation is supported, the second data frame is transmitted using multiple spatial streams.

10. A method of a station (STA) multi-link device (MLD), comprising:
configuring a second link in a multi-link including a first link and the second link as a tunneled direct link setup (TDLS) link for direct communication with a third STA;
receiving, from an access point (AP) MLD, a trigger frame in the multi-link;
transmitting, to the AP MLD, a response frame to the trigger frame in the first link;
performing a communication procedure initiated by the trigger frame with the AP MLD in the first link; and
receiving, from the AP MLD, a first data frame including a TDLS data unit in the first link,
wherein a reception operation of the STA MLD is not performed in the second link after transmission of the response frame, and the TDLS data unit is transmitted from the third STA to the STA MLD in a period in which the reception operation of the STA MLD is not performed in the second link.

11. The method according to claim 10, wherein the first data frame is received based on a tunneling scheme after completion of the communication procedure.

12. The method according to claim 10, wherein the period in which the reception operation of the STA MLD is not performed is a period from a transmission time point of the response frame to a completion time point of the communication procedure initiated by the trigger frame.

13. The method according to claim 10, wherein a data frame received from the AP MLD in the communication procedure includes a ‘more data’ field, and the ‘more data’ field is set to indicate that the first data frame is transmitted after the data frame.

14. The method according to claim 10, wherein when an enhanced multi-link single radio (EMLSR) operation or an enhanced multi-link multi radio (EMLMR) operation is supported, the first data frame is received using multiple spatial streams.

15. An access point (AP) multi-link device (MLD) comprising:
a processor; and
a memory storing one or more instructions executed by the processor,
wherein the one or more instructions are executed to:
transmit a trigger frame in a multi-link, the multi-link including a first link and a second link;
receive, from a first station (STA) affiliated with a STA MLD, a response frame to the trigger frame in the first link;
receive, from a third STA, a first data frame in the second link; and
when a destination of the first data frame is a second STA affiliated with the STA MLD, transmit a second data frame generated based on the first data frame to the first STA in the first link,
wherein the second link is a link established for direct communication between the second STA and the third STA.

16. The AP MLD according to claim 15, wherein the one or more instructions are further executed to perform a communication procedure initiated by the trigger frame with the first STA in the first link, wherein the second data frame is transmitted based on a tunneling scheme after completion of the communication procedure.

17. The AP MLD according to claim 16, wherein a data frame transmitted from the AP MLD to the first STA in the communication procedure includes a ‘more data’ field, and the ‘more data’ field is set to indicate that the second data frame is transmitted after the data frame.

18. The AP MLD according to claim 15, wherein the one or more instructions are further executed to transmit, to the third STA, a reception response frame to the first data frame in the second link, wherein a duration field included in the reception response frame is set to indicate a completion time point of a communication procedure initiated by the trigger frame.

19. The AP MLD according to claim 15, wherein a reception operation of the second STA affiliated with the STA MLD is determined not to be performed in the second link in a period from a transmission time point of the response frame to a completion time point of a communication procedure initiated by the trigger frame.

20. The AP MLD according to claim 19, wherein the one or more instructions are further executed to transmit, in the second link, an action frame including an identifier of the second STA that cannot perform a reception operation in the second link or information on a period in which the reception operation cannot be performed in the second link.
